(19) United States
(12) Patent Application Publication
(10) Pub. No.: US 2005/0104833 A1
(43) Pub. Date: May 19, 2005

(54) Method of driving vertically aligned liquid crystal display

(76) Inventors: Yutaka Ochi, Yokohama-Shi (JP); Masanobu Shigeta, Yokosuka-Shi (JP)

Correspondence Address: JACOBSON HOLMAN PLLC, 400 SEVENTH STREET, N. W., WASHINGTON, DC, 20004, US

(21) Appl. No.: 10/661,808

(22) Filed: Sep. 15, 2003

(30) Foreign Application Priority Data
Mar. 26, 2003 (JP) 2003-85187

(51) Int. Cl. G09G 3/36

(52) U.S. Cl. 345/96

(57) ABSTRACT

A vertically aligned liquid crystal display is driven by a digital drive signal. One field of each of pulses carried by the digital drive signal is divided into a plurality of subfields. Each subfield has a display-off period for which a liquid crystal is not driven and a display-on period for which the liquid crystal is driven. A ratio of the total of the display-on periods over the subfields to the one field is in the range from 1:6 to 5:6. At least a saturated drive voltage is supplied as the digital drive signal to the liquid crystal for each display-on period to modulate light incident in the liquid crystal.

### BACKGROUND OF THE INVENTION

The present invention relates to a method of driving a liquid crystal display, especially, a vertically aligned liquid crystal display, for use in projection displays, view finders, head-mount displays, etc.

Schematically shown in FIG. 1 is one type of known liquid crystal displays for use in projection displays, view finders, head-mount displays, etc.

Major optical components for a liquid crystal display 10 are a reflective active matrix liquid crystal display device 5, a polarization beam splitter (PBS) 6, a projection lens 12, and a screen 13, aligned in this order.

The reflective active matrix liquid crystal display device 5 has a liquid crystal 3 sealed between a pixel electrode 2 and a transparent counter electrode 4. The pixel electrode 2 is provided for each pixel, for reflecting incident light 7. Connected to the pixel electrode 2 is a drive transistor 1 via which a video signal is input from a video-signal source (not shown).

In operation, the incident light 7 is incident in the PBS 6 in a direction perpendicular to an optical passage from the liquid crystal display device 5 to the screen 13.

The incident light 7 has an S-polarized component 8 and a P-polarized component 9. When the light 7 is incident in the PBS 6, the S-polarized component 8 only advances towards the liquid crystal display device 5.

The S-polarized component 8 is then modulated by the liquid crystal 3 that is being driven by a drive voltage, from the drive transistor 1, corresponding to the video signal.

Therefore, light components reflected by the pixel electrode 2 and emitted from the liquid crystal display device 5 are both of the S-polarized and P-polarized components 8 and 9.

The S-polarized and P-polarized components 8 and 9 are incident in the PBS 6 and then the component 9 only advances towards the projection lens 12, as emitted light 11.

The emitted light 11 is projected onto the screen 13 via the projection lens 12 so that an image is displayed on the screen 13.

Illuminance of output light measured on the screen 13 is called intensity of the output light.

Shown in FIG. 2 is a circuit diagram of each pixel of known active matrix liquid crystal display devices.

Multiple of pixels 20 are arranged in a matrix to compose a liquid crystal display device. Each pixel 20 consists of a switching transistor 23, a capacitor 24, and a liquid crystal 25 sealed between a pixel electrode 27 and a counter electrode 26.

The gate G of the switching transistor 23 is connected to a selection line 22 through which a selection signal is supplied. The drain D of the transistor 23 is connected to a data line 21, supplied through which is an input signal corresponding to a video signal.

Upon turn-on of the switching transistor 23 in response to the selection signal, the input signal is stored in the capacitor 24 via the drain D and source S of the transistor 23. The input signal is further supplied to the pixel electrode 27 to drive the liquid crystal 25 sealed between the pixel electrode 27 and the counter electrode 26, thus modulating light incident in the liquid crystal 25.

Illustrated in FIG. 3 is an analog input signal INV corresponding to a video signal, for driving the liquid crystal 25.

The analog input signal INV shown in FIG. 3 continually varies in value and reverses its direction at an interval of one field (1F) against a counter-electrode voltage CEV.

The analog input signal shown in FIG. 3 is composed of an input voltage illustrated in FIG. 4 and specific voltages in accordance with levels from black to white. The voltage at which the intensity of output light emitted from a liquid crystal starts to increase is the threshold voltage Vth (black level). The other voltage at which the intensity of output light starts to saturate is the saturation (drive) voltage Vp (white level).

The curve shown in FIG. 4 indicates intensity of output light versus input voltage Inv supplied to a liquid crystal.

In detail, plotted on the axis of abscissas is a liquid crystal drive voltage (input voltage), a potential difference between a pixel electrode and a counter electrode (CE). The counter electrode is indicated as a CE side in FIG. 4. Plotted on the axis of ordinate is the intensity of output light emitted from a liquid crystal.

A typical method of driving an active matrix liquid crystal with analog signals is disclosed in, for example, Japanese Unexamined Patent Publication No. 2001-59957.

There are demands for higher intensity, higher resolution, and also higher contrast in recent liquid crystal displays and systems, for viewing high-quality images of movies, etc.

Listed below are several types of liquid crystals used in such liquid crystal displays and systems.

(1) Polarization Mode
Ferroelectric Liquid crystal (FLC);
Vertical Aligned (VA);
Hybrid Aligned Nematic (HAN);
Twisted Nematic (TN);

(2) Dispersion Mode
Polymer Dispersed Liquid crystal (PDLC)

(3) Diffraction Mode
Zero Field Diffraction (ZFD)

Liquid crystals used in high picture-quality systems are VA, TN, etc. Particularly, VA is used for obtaining high contrast ratio.

There is a further demand for pixel miniaturization for higher resolution.

As pixel pitch becomes narrow in VA, however, disclination peculiar to liquid crystal devices occur in a certain area of a pixel.

This results in lower modulation transfer function (MTF) due to lower intensity. It also produces adverse effects in which disclinated portions become a complementary color in color combination for color-image displaying.

Moreover, it is speculated that VA will not be efficient for further higher resolution (narrower pixel pitch), as discussed in SID′ 99 Digest, p. 750-753, 1999.

Disclination will be discussed in detail with reference to FIGS. 5 to 8. Illustrated in FIG. 5 are a row of pixels G11, G21 and G31 displaying black, a row of pixels G12, G22 and G32 displaying white, and a row of pixels G13, G23 and G33 displaying black. No disclination occurs in these pixels.

In contrast, illustrated in FIG. 6 are a row of pixels G′11, G′21 and G′31 displaying black, a row of pixels G′12, G′22 and G′32 displaying white, and a row of pixels G′13, G′23 and G′33 displaying black. Disclination occurs in the row of pixels G′12, G′22 and G′32, so that black is displayed on a part of each of these pixels, which should have been displayed in white completely.

Indicated in FIG. 7 is change in brightness when disclination occurs, according to the position on pixels PX1, PX2 and PX3. The maximum disclination occurs when the threshold voltage Vth and the saturation drive voltage Vp, shown in FIG. 4, are supplied to the pixels PX1 and PX3, and the pixel PX2, respectively. The degree of disclination is indicated by a sign D in FIG. 7.

Illustrated in FIG. 8 is a liquid crystal with no electric field applied in vertically aligned liquid crystal displays.

FIG. 8 shows that a long axis 74 of a liquid crystal molecule 72 tilts from a normal line 73 on a vertical alignment film 75 on a substrate 61 (pixel electrode) The direction of orientation is indicated by an arrow 76 and a dot line 76′ in relation to a leg 77 of the substrate 61. The angle θLC between the long axis 74 and the normal line 73 is called a pretilt angle. In liquid crystal displays, the degree D of disclination hardly varies when a liquid crystal cell thickness and a pretilt angle are constant. This results in large adverse effects of disclination as the pixel pitch becomes narrower.

This phenomenon often occurs in analog-driven VA types for high-contrast displaying.

Another known drive method is to digitally drive each pixel in liquid crystal displays.

This digital drive method is to control voltages in R. M. S. (Root Mean Square) for an input signal supplied to a liquid crystal of each pixel based on PWM (Pulse Width Modulation) in which the duration of the input signal is varied in accordance with the intensity (gradation) of an image while the amplitude of the input signal is constant.

Illustrated in FIG. 9 is a typical waveform of a digital input (video) signal supplied to liquid crystal displays.

This input waveform is applied to 6-bit gradation. One field (1F) duration is 16.7 msec when the field frequency is 60 Hz. One field consists of subfields B0 to B5. The combination of the subfields B0 to B5 offers 64-bit gradation displaying.

One subfield consists of a display-on period for which a liquid crystal is driven and a display-off period for which the liquid crystal is not driven.

The display-off period in every one subfield is, for example, 0.1 msec for which a threshold voltage Vth is supplied to a liquid crystal.

The subfield B0 lasts for 0.26 msec, so that a saturation voltage Vp is supplied to the liquid crystal for 0.16 msec in display-on period.

The subfield B1 lasts for 0.53 msec, so that the saturation voltage Vp is supplied to the liquid crystal for 0.43 msec in display-on period.

The subfield B2 lasts for 1.06 msec, so that the saturation voltage Vp is supplied to the liquid crystal for 0.96 msec in display-on period.

The subfield B3 lasts for 2.12 msec, so that the saturation voltage Vp is supplied to the liquid crystal for 2.02 msec in display-on period.

The subfield B4 lasts for 4.23 msec, so that the saturation voltage Vp is supplied to the liquid crystal for 4.13 msec in display-on period.

The subfield B5 lasts for 8.46 msec, so that the saturation voltage Vp is supplied to the liquid crystal for 8.36 msec in display-on period.

These periods for the digital input signal supplied to the liquid crystal are shown in TABLE 1.

TABLE 1
SUBFIELD PERIIOD DISPLAY-ON PERIIOD DISPLAY-OFF PERIIOD

| | (msec) | (msec) | (msec) |
|---|---|---|---|
| B0 | 0.26 | 0.16 | 0.10 |
| B1 | 0.53 | 0.43 | 0.10 |
| B2 | 1.06 | 0.96 | 0.10 |
| B3 | 2.12 | 2.02 | 0.10 |
| B4 | 4.23 | 4.13 | 0.10 |
| B5 | 8.46 | 8.36 | 0.10 |

In display of black (with the minimum intensity of output light from a liquid crystal), a threshold voltage Vth is supplied to the liquid crystal of each pixel for one field.

On the contrary, in display of white (with the maximum intensity of output light from a liquid crystal), a saturation voltage Vp is supplied to the liquid crystal of each pixel for one field except the display-off period.

In gradation levels between white and black, the saturation voltage Vp is supplied to the liquid crystal of each pixel for a display-on period which corresponds to the combination of the display-on periods in the subfields B0 to B5, in accordance with gradation colors.

Under these conditions, supply of the threshold voltage Vth (black) to the pixels PX1 and PX3, and the saturation voltage Vp (white) to the pixel PX2, in FIG. 7, results in the saturation voltage Vp supplied for almost one-field period (with 16.1 msec in display-on period), thus disclination being occurred, like analog driving.

Therefore, the known analog and digital driving methods described above cause disclination for vertically aligned liquid crystal displays, and thus resulting in lower image quality.

A larger liquid crystal pretilt angle, a thinner liquid crystal cell thickness, etc., could decrease the disclination. Nevertheless, a larger liquid crystal pretilt angle lowers contrast. In addition, a thinner liquid crystal cell thickness requires a lager drive voltage. Pixel miniaturization leads to transistor miniaturization with lower withstanding voltage which, in other words, a higher voltage cannot be supplied to a liquid crystal, resulting in inefficient liquid crystal driving.

As discussed above in detail, it is very difficult to achieve high resolution, high contrast and a rare occurrence of disclination in pixel-miniaturized liquid crystal displays equipped with vertically aligned liquid crystals.

### SUMMARY OF THE INVENTION

A purpose of the present invention is to provide a method of driving a vertically aligned liquid crystal display with high contrast, high resolution and a rare occurrence of disclination.

The present invention provides a method of driving a vertically aligned liquid crystal display comprising the steps of: dividing one field of each of pulses carried by a digital drive signal into a plurality of subfields, each subfield having a display-off period for which a liquid crystal is not driven and a display-on period for which the liquid crystal is driven, a ratio of the total of the display-on periods over the subfields to the one field being in the range from 1:6 to 5:6; and supplying at least a saturated drive voltage as the digital drive signal to the liquid crystal for each display-on period to modulate light incident in the liquid crystal.

### BRIEF DESCRIPTION OF DRAWINGS

FIG. 1 is a schematic configuration of a known liquid crystal display equipped with a reflective liquid crystal display device;

FIG. 2 is a circuit diagram of each pixel of a known active matrix liquid crystal display device;

FIG. 3 is an illustration of an analog input (video) signal supplied to a known active matrix liquid crystal display device;

FIG. 4 is a graph indicating output-light intensity versus voltage supplied to a liquid crystal;

FIG. 5 is an illustration of black and white alternately displayed on pixels adjacent to each other;

FIG. 6 is an illustration of black and white alternately displayed on pixels adjacent to each other, with disclination occurring in some pixels;

FIG. 7 is a graph indicating occurrence of disclination in pixels adjacent to each other;

FIG. 8 is an illustration of pretilt angle in vertical aligned liquid crystals;

FIG. 9 is an illustration of a known digital input (video) signal supplied to liquid crystal display devices;

FIG. 10 is an illustration of a digital input (video) signal supplied to each pixel in a method of driving a vertical aligned liquid crystal display device according to the present invention;

FIG. 11A is an illustration of the order of subfields to be turned on and generation of moving-picture pseudo image contour;

FIG. 11B is an illustration of the order of subfields to be turned on in the method of driving the vertical aligned liquid crystal display device according to the present invention;

FIG. 12 is a circuit diagram of each pixel of the vertical aligned liquid crystal display device according to the present invention;

FIG. 13 is an illustration of a timing chart for signals supplied to each pixel of the vertical aligned liquid crystal display device according to the present invention;

FIG. 14 is a graph indicating output-light intensity versus input signal supplied to the liquid crystal of each pixel of the vertical aligned liquid crystal display device according to the present invention;

FIG. 15 is a schematic configuration of an ion-beam assist deposition system;

FIG. 16 is a schematic illustration of placement of a substrate in formation of an alignment film;

FIG. 17 is a graph indicating output-light intensity and degree of disclination versus PWM-input signal voltage in R. M. S. to a liquid crystal display device;

FIG. 18 is an illustration of a liquid crystal drive voltage in a display-on period;

FIG. 19 is a graph indicating output-light intensity versus liquid crystal drive voltage at several levels of viscosity; and

FIG. 20 is a graph indicating degree of disclination versus pixel size and pretilt angle.

### DETAILED DESCRIPTION OF PREFERRED EMBODIMENT

An embodiment according to the present invention will be disclosed with reference to the attached drawings.

### Embodiment

The inventors have reached the present invention based on their findings as follows:

Light output from a liquid crystal exhibits a high rising speed but a low falling speed in response to a digital input signal (liquid crystal response property, or light output property against voltage application). A large light output is thus gained against a short input-signal pulse width. Therefore, a digital input signal having pulses each having a wide pulse width divided into several pulses of short pulse widths effectively lowers a voltage between adjacent pixels, thus suppressing disclination.

Disclosed first is a digital drive method in this embodiment.

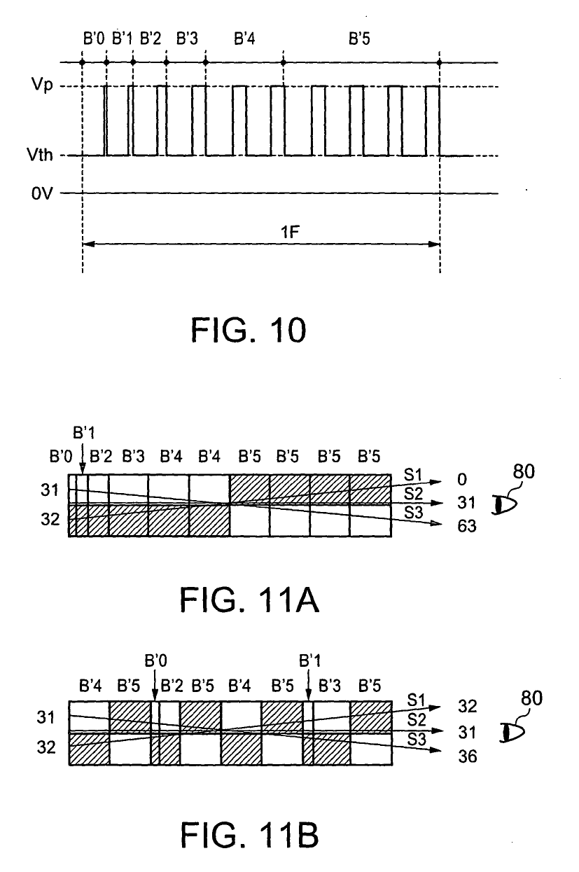

Illustrated in FIG. 10 is a waveform of a digital input (video) signal to be supplied to pixels in a method of driving a vertically aligned liquid crystal display in this embodiment.

The threshold voltage Vth and the saturation voltage Vp are, for example, 1.5 volts and 4 volts, respectively, in the following disclosure.

Like the digital signal having the subfields B0 (LSB) to B5 (MSB) shown in FIG. 9, the digital input signal in FIG. 10 has subfields B′0 (LSB) to B′5 (MSB) for 6-bit gradation.

In addition, the digital input signal shown in FIG. 10 is adjusted in each subfield to have a narrow pulse width for the saturation voltage Vp and a specific display-off period for which the threshold voltage Vth is supplied.

Displaying several gradations of color is achieved with selection and combination of the subfields for which the saturation voltage Vp is supplied. The threshold voltage Vth is supplied for each subfield when no saturation voltage Vp is supplied.

Disclosed below are several cases in which the ratio of display-on period to one-field period in one field (1F) is varied, which is the ratio of the total of display-on periods over the subfields to one-field period in displaying white.

(CASE 1)

The ratio of display-on period to one-field period in one field is about 1:6 in CASE 1.

The digital input signal shown in FIG. 10 is adjusted so that the subfields B′4 and B′5 each having a long duration for which disclination occurs are separated into several pulses having a Vp-supplying period of 0.36 msec or less while maintaining the ratio 1:6 in supplying the saturation voltage Vp for a specific period over the subfields B′0 to B′5, with 1.38 msec in display-off period for each subfield.

In detail, the pulse widths (display-on period) for the subfields B′0, B′1, B′2 and B′3 each having one pulse are 0.05 msec, 0.09 msec, 0.18 msec and 0.36 msec, respectively. The pulse width (display-on period) for the subfield B′4 having two pulses is 0.36 msec for each pulse. The pulse width (display-on period) for the subfield B′5 having four pulses is 0.36 msec for each pulse. The saturation voltage Vp is supplied for the duration of each pulse width (display-on period).

These periods for the digital input signal in CASE 1 are shown in TABLE 2.

TABLE 2
SUBFIELD PERIOD DISPLAY-ON PERIIOD NUMBER OF PULSE
DISPLAY-OFF PERIIOD

| | (msec) | (msec) | | (msec) |
|---|---|---|---|---|
| B′0 | 1.43 | 0.05 | 1 | 1.38 |
| B′1 | 1.47 | 0.09 | 1 | 1.38 |
| B′2 | 1.56 | 0.18 | 1 | 1.38 |
| B′3 | 1.74 | 0.36 | 1 | 1.38 |
| B′4 | 3.48 | 0.36 | 2 | 1.38 |
| B′5 | 6.96 | 0.36 | 4 | 1.38 |

(CASE 2)

The ratio of display-on period to one-field period in one field is about 1:3 in CASE 2.

The digital input signal shown in FIG. 10 is adjusted so that the subfields B′4 and B′5 each having a long duration for which disclination occurs are separated into several pulses having a Vp-supplying period of 0.7 msec or less while maintaining the ratio 1:3 in supplying the saturation voltage Vp for a specific period over the subfields B′0 to B′5, with 1.12 msec in display-off period for each subfield.

In detail, the pulse widths (display-on period) for the subfields B′0, B′1, B′2 and B′3 each having one pulse are 0.08 msec, 0.16 msec, 0.33 msec and 0.68 msec, respectively. The pulse width (display-on period) for the subfield B′4 having two pulses is 0.7 msec for each pulse. The pulse width (display-on period) for the subfield B′5 having four pulses is 0.7 msec for each pulse. The saturation voltage Vp is supplied for the duration of each pulse width (display-on period).

These periods for the digital input signal in CASE 2 are shown in TABLE 3.

TABLE 3
SUBFIELD PERIOD DISPLAY-ON PERIIOD NUMBER OF PULSE
DISPLAY-OFF PERIIOD

| | (msec) | (msec) | | (msec) |
|---|---|---|---|---|
| B′0 | 1.20 | 0.08 | 1 | 1.12 |
| B′1 | 1.28 | 0.16 | 1 | 1.12 |
| B′2 | 1.45 | 0.33 | 1 | 1.12 |
| B′3 | 1.80 | 0.68 | 1 | 1.12 |
| B′4 | 3.64 | 0.70 | 2 | 1.12 |
| B′5 | 7.28 | 0.70 | 4 | 1.12 |

(CASE 3)

The ratio of display-on period to one-field period in one field is about 1:2 in CASE 3.

The digital input signal shown in FIG. 10 is adjusted so that the subfields B′4 and B′5 each having a long duration for which disclination occurs are separated into several pulses having a Vp-supplying period of 1.06 msec or less while maintaining the ratio 1:2 in supplying the saturation voltage Vp for a specific period over the subfields B′0 to B′5, with 0.84 msec in display-off period for each subfield.

In detail, the pulse widths (display-on period) for the subfields B′0, B′1, B′2 and B′3 each having one pulse are 0.13 msec, 0.26 msec, 0.53 msec and 1.06 msec, respectively. The pulse width (display-on period) for the subfield B′4 having two pulses is 1.06 msec for each pulse. The pulse width (display-on period) for the subfield B′5 having four pulses is 1.06 msec for each pulse. The saturation voltage Vp is supplied for the duration of each pulse width (display-on period).

These periods for the digital input signal in CASE 3 are shown in TABLE 4.

TABLE 4
SUBFIELD PERIOD DISPLAY-ON PERIIOD NUMBER OF PULSE
DISPLAY-OFF PERIIOD

| | (msec) | (msec) | | (msec) |
|---|---|---|---|---|
| B′0 | 0.97 | 0.13 | 1 | 0.84 |
| B′1 | 1.10 | 0.26 | 1 | 0.84 |
| B′2 | 1.37 | 0.53 | 1 | 0.84 |
| B′3 | 1.90 | 1.06 | 1 | 0.84 |
| B′4 | 3.80 | 1.06 | 2 | 0.84 |
| B′5 | 7.60 | 1.06 | 4 | 0.84 |

(CASE 4)

The ratio of display-on period to one-field period in one field is about 2:3 in CASE 4.

The digital input signal shown in FIG. 10 is adjusted so that the subfields B′4 and B′5 each having a long duration for which disclination occurs are separated into several pulses having a Vp-supplying period of 1.4 msec or less while maintaining the ratio 2:3 in supplying the saturation voltage Vp for a specific period over the subfields B′0 to B′5, with 0.57 msec in display-off period for each subfield.

In detail, the pulse widths (display-on period) for the subfields B′0, B′1, B′2 and B′3 each having one pulse are 0.16 msec, 0.35 msec, 0.7 msec and 1.4 msec, respectively. The pulse width (display-on period) for the subfield B′4 having two pulses is 1.4 msec for each pulse. The pulse width (display-on period) for the subfield B′5 having four pulses is 1.4 msec for each pulse. The saturation voltage Vp is supplied for the duration of each pulse width (display-on period).

These periods for the digital input signal in CASE 4 are shown in TABLE 5.

TABLE 5
SUBFIELD PERIOD DISPLAY-ON PERIIOD NUMBER OF PULSE
DISPLAY-OFF PERIIOD

| | (msec) | (msec) | | (msec) |
|---|---|---|---|---|
| B′0 | 0.73 | 0.16 | 1 | 0.57 |
| B′1 | 0.92 | 0.35 | 1 | 0.57 |
| B′2 | 1.27 | 0.70 | 1 | 0.57 |
| B′3 | 1.97 | 1.40 | 1 | 0.57 |
| B′4 | 3.94 | 1.40 | 2 | 0.57 |
| B′5 | 7.88 | 1.40 | 4 | 0.57 |

(CASE 5)

The ratio of display-on period to one-field period in one field is about 5:6 in CASE 5.

The digital input signal shown in FIG. 10 is adjusted so that the subfields B′4 and B′5 each having a long duration for which disclination occurs are separated into several pulses having a Vp-supplying period of 1.76 msec or less while maintaining the ratio 5:6 in supplying the saturation voltage Vp for a specific period over the subfields B′0 to B′5, with 0.28 msec in display-off period for each subfield.

In detail, the pulse widths (display-on period) for the subfields B′0, B′1, B′2 and B′3 each having one pulse are 0.22 msec, 0.43 msec, 0.88 msec and 1.76 msec, respectively. The pulse width (display-on period) for the subfield B′4 having two pulses is 1.76 msec for each pulse. The pulse width (display-on period) for the subfield B′5 having four pulses is 1.76 msec for each pulse. The saturation voltage Vp is supplied for the duration of each pulse width (display-on period).

These periods for the digital input signal in CASE 5 are shown in TABLE 6.

TABLE 6
SUBFIELD PERIOD DISPLAY-ON PERIIOD NUMBER OF PULSE
DISPLAY-OFF PERIIOD

| | (msec) | (msec) | | (msec) |
|---|---|---|---|---|
| B′0 | 0.50 | 0.22 | 1 | 0.28 |
| B′1 | 0.71 | 0.43 | 1 | 0.28 |
| B′2 | 1.16 | 0.88 | 1 | 0.28 |
| B′3 | 2.04 | 1.76 | 1 | 0.28 |
| B′4 | 4.08 | 1.76 | 2 | 0.28 |
| B′5 | 8.16 | 1.76 | 4 | 0.28 |

In TABLES 2 to 6, SUBFIELD PERIOD indicates the duration of each subfield, DISPLAY-ON PERIIOD indicates a pulse width for which the saturation voltage Vp is supplied, and DISPLAY-OFF PERIIOD indicates the duration for which the threshold voltage Vth is supplied.

As shown in FIG. 10, the subfields B′0, B′1, B′2, B′3, B′4 and B′ 5 are turned on in this order in one field (1F) in CASES 1 to 5.

The subfield-based drive method described above, however, produces sharp moving-picture pseudo image contour, as illustrated in FIG. 11A.

Indicated in FIG. 11A is the order of subfields to be turned on versus moving-picture pseudo image contour in 64-gradation displaying between white and black. The axis of ordinate and axis of abscissas indicate the location of pixels and time, respectively, in FIG. 11A.

When a moving picture moves rapidly, difference in time is converted into difference in space, and hence pseudo image contour is produced, thus lowering moving-picture quality.

FIG. 11A indicates that the subfields B′0, B′1, B′2, B′3, B′4 and B′ 5 are turned on in this regular order at a gradation level 31 for an upper pixel and a gradation level 32 for a lower pixel 31 adjacent to the upper pixel.

Oblique line zones in FIG. 11A indicates no pulses. In contrast, no oblique-line zones in FIG. 11A indicate pulses, or one pulse for each of the subfields B′0, B′1, B′2 and B′3, two pulses for the subfield B′4, and four pulses for the subfield B′5.

Pulses are supplied to the upper pixel (turned on) from the subfield B′0 to B′ 4, and then no pulses are supplied thereto (turned off) in the succeeding subfield B′5, at the gradation level 31. On the contrary, no pulses are supplied to the lower pixel (turned off) from the subfield B′0 to B′4, and then pulses are supplied thereto (turned on) in the succeeding subfield B′5, at the gradation level 32.

When a viewer moves his or her eye 80 among positions S1, S2 and S3, brightness at these positions is gradation levels 0, 31 and 63, respectively, on the retina of the eye 80, different from when the eye 80 is fixed at any of these positions.

Reduction of moving-picture pseudo image contour is achieved as illustrated in FIG. 11B in which the subfields are turned on in an irregular order, such as, B′4, B′5, B′0, B′2, B′5, B′4, B′5, B′1, B′3 and B′5 in one field, different from the regular order shown in FIG. 11A.

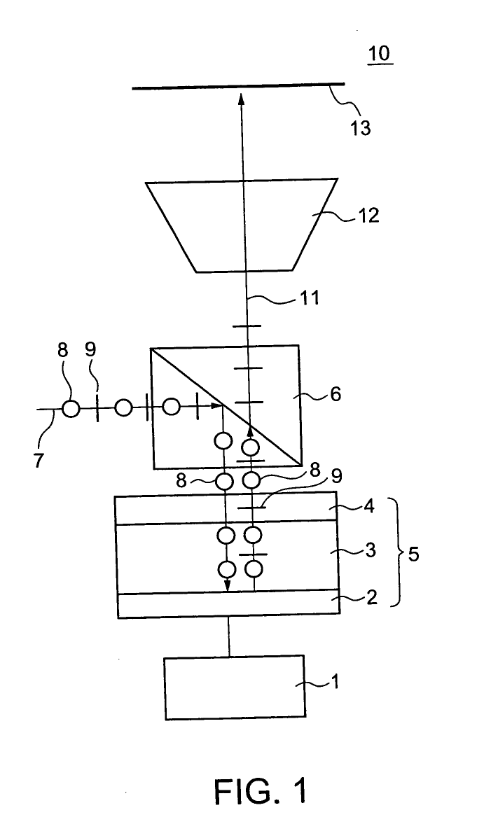

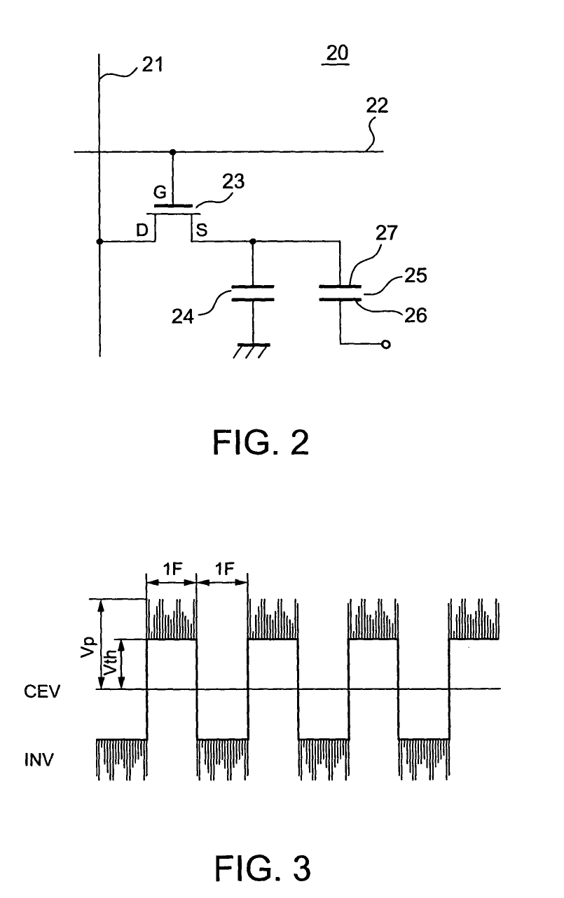

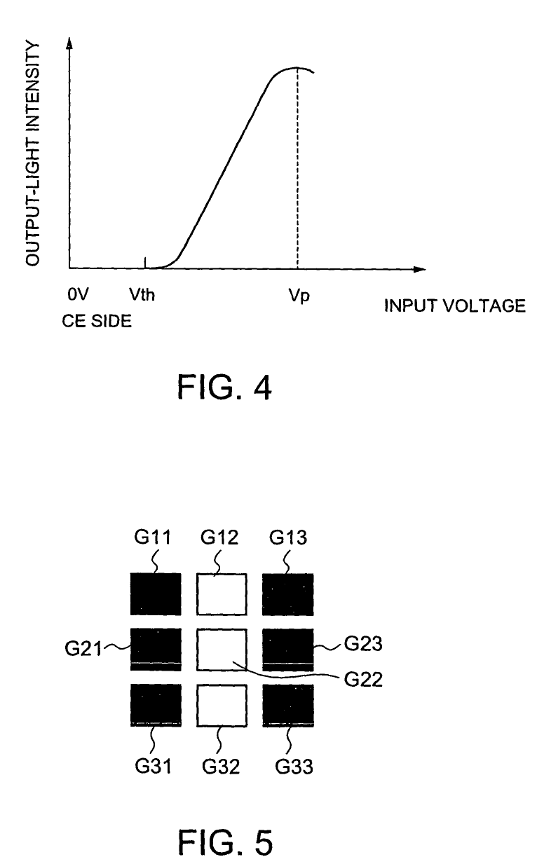

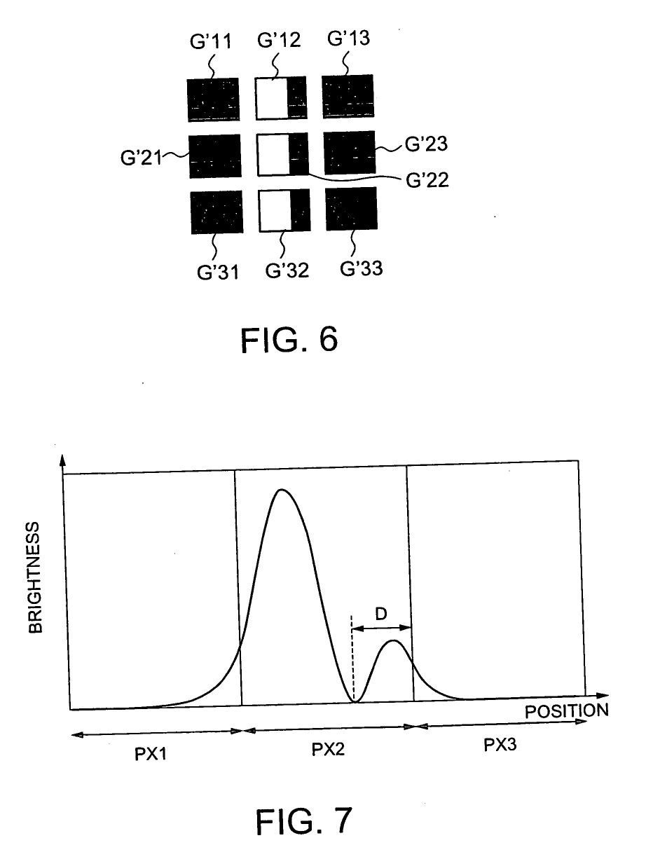

Brightness at the positions S1, S2 and S3 in FIG. 11B is gradation levels 36, 31 and 32, respectively, on the retina of the moving eye 80, improved from the regular order shown in FIG. 1A.

In displaying a moving picture, the subfields are turned on in the order such as indicated in FIG. 11B in one field.

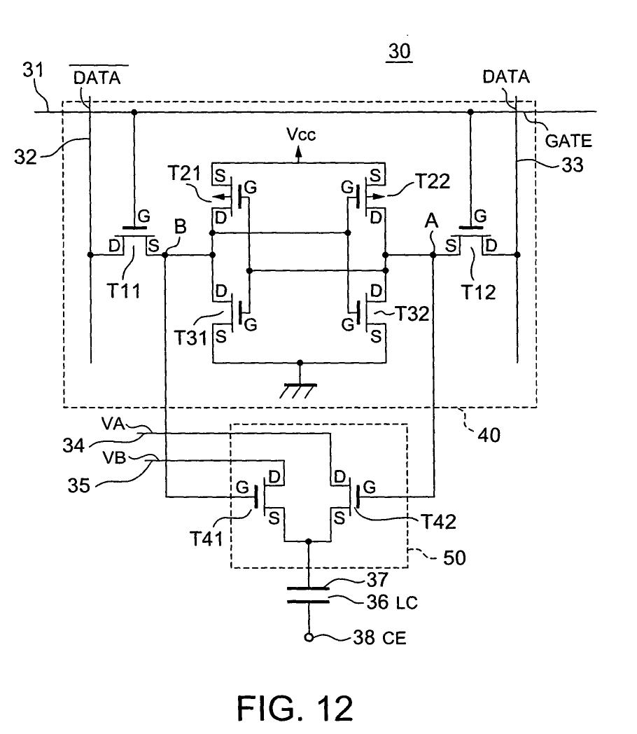

Disclosed next with reference to FIG. 12 is a circuit configuration for each pixel of a liquid crystal display in this invention.

As shown in FIG. 12, provided for each pixel 30 are a sampling/hold circuit 40, a pixel switch 50, a pixel electrode 37, a counter electrode (CE) 38, and a liquid crystal (LC) 36 filled between these electrodes.

The sampling/hold circuit 40 is an SRAM equipped with 6 transistors T11, T12, T21, T22, T31 and T32. A selection line 31 is connected to the gates G of the transistors T11 and T12. A data line 32 is connected to the drain D of the transistor T11. Connected to the drain D of the transistor T12 is a data line 33 supplied through which is data, an inverted version of data supplied through the data line 32.

The pixel switch 50 consists of two transistors T41 and T42. The gate G, the drain D, and the source S of the transistor T41 are connected to the source S of the transistor T11 (node B in FIG. 12), a second switch line 35, and the pixel electrode 37, respectively. The gate G, the drain D, and the source S of the transistor T42 are connected to the source S of the transistor T12 (node A in FIG. 12), a first switch line 34, and the pixel electrode 37, respectively.

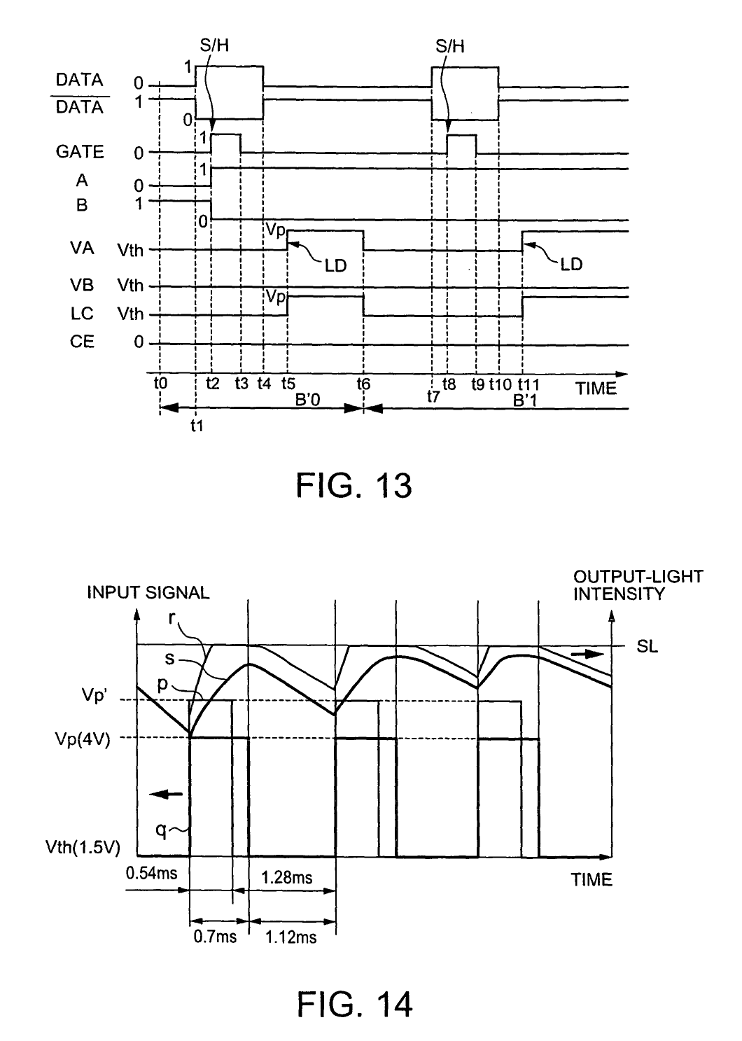

An operation of the circuit shown in FIG. 12 for each pixel 30 is explained with reference to a timing chart illustrated in FIG. 13.

Supplied to the data line 33 is video-signal data DATA that is “1” from time t1 but “0” at time t4 in the subfield B′0. In other words, a video signal appears from time t1 to time t4 in the subfield B′0. Supplied to the data line 32 is video-signal data /DATA that is “0” from time t1 but “1” at time t4 in the subfield B′0.

The video-signal data DATA and /DATA are temporarily stored in the sampling/hold circuit 40 when a gate pulse GATE (“1” from time t2 but “0” at time t3) is supplied to the selection line 31, for sampling/hold (S/H). Thus, data “1” and “0” appear at the nodes A and B, respectively.

The pixel switch 50 supplies a voltage to the pixel electrode 37 to drive the liquid crystal 36. In detail, A signal VA (threshold voltage Vth) and another signal VB (Vth) are supplied to the pixel switch 50 through the first and second signal lines 34 and 35, respectively, for a sampling/hold period from time t1 to t5 (sampling/hold actually begins at time 2). This results in the threshold voltage Vth and 0 volts being supplied to the pixel electrode 37 and counter electrode (glass transparent electrode CE) 38, respectively, thus the threshold voltage Vth being supplied to the liquid crystal (LC) 36 that is constantly displaying black.

One-subfield data is temporarily stored in the sampling/hold circuit 40 for every pixel during the sampling/hold period (from t1 to t5). The one-subfield data is stored in the circuit 40 for the display-off period including a pause period, until a liquid crystal drive (LD) period (from time t5 to t6 in the subfield B′0) starts. The pause period is set to have 1.38 msec to 0.28 msec in the display-off periods against the display-on periods having the ratio 1:6 to 5:6 to one-field period, as discussed in CASES 1 to 5, respectively.

The liquid crystal 36 is driven by a digital signal for the liquid crystal drive period (from time t5 to t6 in the subfield B′0 in FIG. 13) for all pixels simultaneously. The signals supplied to the pixel switch 50 during the liquid crystal drive period are the signal VA having the saturation voltage Vp and the signal VB having the threshold voltage Vth, through the first and second signal lines 34 and 35, respectively, from an external circuit (not shown). The saturation and threshold voltages Vp and Vth can be set at any appropriate levels.

The liquid crystal drive period is the display-on period set freely in each of the subfields B′0 to B′5 constituting one field. For example, the display-on periods are 0.08 msec, 0.16 msec, 0.33 msec, 0.68 msec, 0.7 msec, and 0.7 msec in the subfields B′0, B′1, B′2, B′3, B′4 (2 pulses), and B′5 (4 pulses), respectively, at the ratio 1:3 for the display-on period to one field (CASE 2).

As indicated in FIG. 13, the subfield B′1 comes right after time t6 at which liquid crystal driving finishes. The video signals DATA and /DATA are supplied to the data lines 32 and 33, respectively, for the same processing in the subfield B′1 as in the subfield B′0, disclosed above. The same is performed for the subfields B′2 to B′5 to finish one field.

The threshold voltage Vth is supplied to the liquid crystal 36 to display black when data “0” has been stored in the sampling/hold circuit 40. In contrast, the saturation voltage Vp is supplied to the liquid crystal 36 to display white when data “1” has been stored in the sampling/hold circuit 40.

Discussed next is output light emitted from the liquid crystal 36 driven by the digital signal constituted by the subfields B′0 to B′5, as described above.

Shown in FIG. 14 is output-light intensity versus a digital input signal supplied to the liquid crystal 36 in the subfield B′5 at the ratio 1:3 for the display-on period to one-field period (CASE 2, TABLE 3).

A pulse signal “q” has 0.7 msec in width and (Vp−Vth) in voltage for each of pulses with an interval of 1.12 msec between the pulses.

Light emitted from the liquid crystal 36 varies as indicated by a curve “s” in response the input pulse signal “q”. The curve “s” indicates that the output light has a high rising speed but a low falling speed. The curve “s” teaches that a sufficient amount of output light can be gained from a liquid crystal against the pulse signal “q” of narrow pulse width.

The subfields B′4 and B′5 have two and four pulses, respectively, in the foregoing disclosure. The number of pulses and pulse width can be freely set under the requirement, the ratio of display-on period to one-field period, as disclosed above.

Moreover, the above disclosure employs 6-bit input as an example, which may however be 8 bits, 10 bits, 12 bits, etc.

Discussed next is evaluation of disclination for a vertically-aligned liquid crystal display produced and driven by the drive method under the present embodiment.

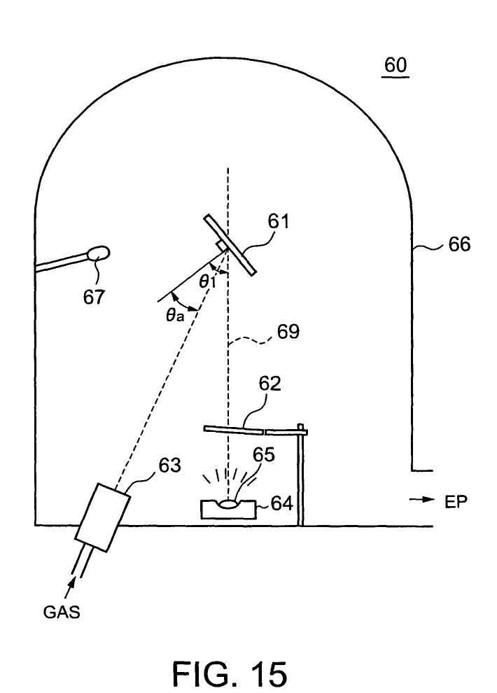

Explained first with reference to FIG. 15 is an ion-beam assist deposition system 60 used for producing the vertically-aligned liquid crystal display in this embodiment.

As illustrated in FIG. 15, a vacuum chamber 66 is connected to an exhaust pump EP (not shown) so that a specific degree of vacuum is maintained inside the chamber.

Provided on the bottom of the vacuum chamber 66 is an electron-beam (EB) gun 64 for heating an evaporation source 65 to promote evaporation. A shutter 62 is provided above the EB gun 64, for control of evaporation.

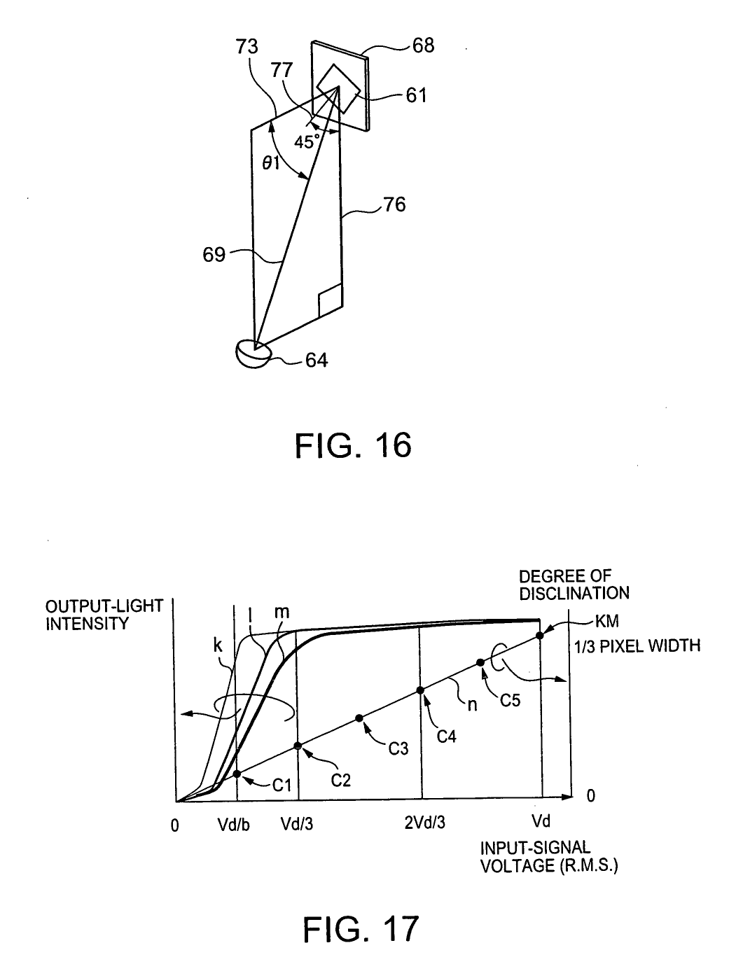

A substrate 61 is held by a substrate holder 68 (shown in FIG. 16). Freely set is an angle θ1 between a normal line 73 on the substrate surface and a virtual line connecting the center of the substrate 61 and that of the EB gun 64.

The substrate 61 is set in the vacuum chamber 66, as illustrated in FIG. 16.

FIG. 16 illustrates how the substrate 61 is set in formation of an alignment film. In detail, the substrate 61 is set on the substrate holder 68 as rotated by 45 degrees on the holder 68 to have a direction (orientation direction) 76 in which a liquid crystal is oriented at 45 degrees from a leg 77 of a square pixel. In addition, it is set on the substrate holder 68 so that the normal line 73 on the substrate surface, an evaporation flow 69 from the EB gun 64, and the orientation direction 76 are set on the same plane.

Also provided on the bottom of the vacuum chamber 66 is an ion gun 63 to ionize gas supplied from outside and radiate the ionized gas at a tilt angle θa, as shown in FIG. 15.

The thickness of evaporated substances 65 deposited on the substrate 61 is monitored by a thickness monitor 67.

The vertically aligned liquid crystal display in this embodiment is produced in the following manners with the ion-beam assist deposition system 60.

Formed on a silicon substrate is a digital active matrix circuit including the sampling/hold circuit 40, the pixel switch 50 and the pixel electrode 37, shown in FIG. 12, thus a digital-drive active matrix substrate being produced. The pixel electrode 37 is produced in 15-μm pitch so that its size facing the liquid crystal 36 is (14 μm×14 μm) with a gap of 1 μm.

Prepared next is a transparent glass substrate having a transparent electrode formed thereon.

An SiO₂-alignment film is formed on each of the pixel electrode on the silicon substrate and the transparent electrode on the glass substrate in the ion-beam assist deposition system 60.

In FIG. 15, the substrate 61 (the silicon substrate or the glass substrate) is tilted from the evaporation source 65. In detail, the normal line of the substrate 61 is tilted at 63 degrees (=θ1) from a virtual line connecting the center of the substrate 61 and the evaporation source 65 that is SiO₂.

The evaporation source (SiO₂) 65 is evaporated at an evaporation speed of 8 angstrom/sec while O₂ gas is ionized by and radiated from the ion gun 63 (operating at 800V-80 mA) to the substrate 61 to form an SiO₂ film of 750 angstrom in thickness thereon.

The digital-drive active matrix substrate and the transparent glass substrate are then joined to each other via 3.0-μm spacers as the alignment films formed thereon facing each other, thus a cell being produced.

A nematic liquid crystal exhibiting negative dielectric anisotropy and viscosity at 15 cp is injected into the cell to produce the vertically-aligned liquid crystal display in this embodiment. The viscosity for the nematic liquid crystal is preferably in the range from 1 to 100 cp, and more preferably from 10 to 50 cp, in this embodiment.

The digital input signal shown in FIG. 10 is supplied to the vertically aligned liquid crystal display in this embodiment under the requirements discussed in CASES 1 to 5 for measurements of voltage Vd in R. M. S. and degree of disclination.

FIG. 17 shows output-light intensity and degree of disclination versus PWM-input signal voltage in R. M. S.

The input voltage in R. M. S. is supplied to the liquid crystal when the saturation voltage Vp is always supplied thereto during one field, like analog driving discussed first.

According to TABLE 2 (CASE 1), the total pulse width for 10 pulses in the subfields B′0 to B′5 is 2.84 msec, thus the voltage in R. M. S. is Vd/6.

Indicated in FIG. 17 is the degree of disclination occurring on the center pixel sandwiched by two pixels while the threshold voltage Vth is supplied to the two pixels for displaying black and a certain voltage is supplied to the center pixel for displaying almost white, in the vertically aligned liquid crystal display in this embodiment.

A curve “m” in FIG. 17 indicates output light versus input-signal voltage in R. M. S. supplied to the liquid crystal while the display-on period (pulse width) is varied at the constant voltage (Vp−Vth) for the pulse signal “q” in FIG. 14.

A straight line “n” in FIG. 17 indicates the degree of disclination against input-signal voltage in R. M. S., plotted for CASES 1 to 5 (C1 to C5), and also for a known method KM in which an input voltage Vd in R. M. S. is continuously supplied during one-field period.

FIG. 17 teaches that the degree of disclination in this embodiment is smaller than the known method M, under the requirements in that the ratio of liquid crystal drive (display-on) period to one-field period is in the range from 1:6 to 5:6, or input-signal voltage in R. M. S. is in the range from Vd/6 to 5 Vd/6.

Also taught by FIG. 17 is that output-light intensity at input-signal voltage in R. M. S. in the range from Vd/2 to 5 Vd/6 is almost the same as at Vd, whereas it is lowered to about 80% of intensity at Vd when the input-signal voltage in R. M. S. is Vd/3, and to about 35% of intensity at Vd when the input-signal voltage in R. M. S. is Vd/6. The output-light intensity in practical use requires about 70% of intensity at Vd when the input-signal voltage in R. M. S. is lower than Vd.

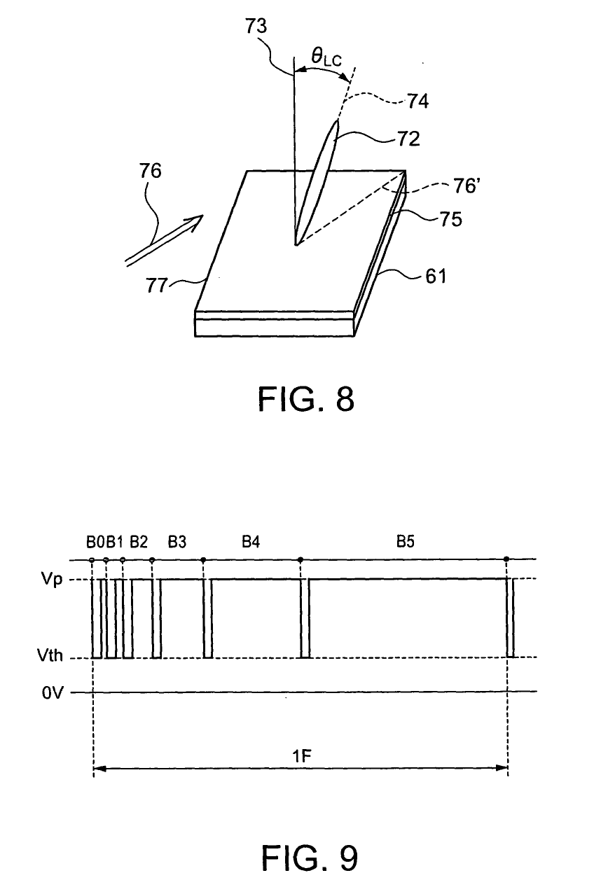

When the measurements in FIG. 17 are applied to a liquid crystal display, results are almost no disclination, 1500:1 in contrast ratio, and 2.5 degrees in pretilt angle θLC between the liquid crystal molecule 72 and the normal line 73 on the subastrate 61 (FIG. 8).

The pretilt angle θLC was measured by crystal rotation for a sample cell, produced with the cell disclosed above, but equipped with a glass substrate having a transparent conductive film instead of the silicon substrate.

As disclosed in detail, the method of driving the vertically aligned liquid crystal display in this embodiment offers high image quality while lowering the degree of disclination.

With reference to FIG. 17 again, the curve “m” and the straight line “n” indicate small degree of disclination and low output light intensity as the input-signal voltage in R. M. S. decreases to Vd/3. Nevertheless, a larger voltage to drive a liquid crystal and also a larger viscosity (discussed later) of the liquid crystal offer sufficiently high output light intensity at Vd/3 and Vd/6.

Discussed next with reference to FIG. 14 again is application of large liquid crystal drive (input) signal.

A pulse signal “p” is equivalent to the pulse signal “q” having the same voltage in R. M. S. It has a pulse width of 0.54 msec and a pulse interval of 1.28 msec at voltage (Vp′−Vth)=1.3(Vp−Vth). Application of the pulse signal “p” to the liquid crystal gives a curve “r” that indicates variation in output light intensity from the liquid crystal as time elapses. The curve “r” indicates higher output light intensity (up to an output-light saturated level SL) than the curve “s”.

Application of the pulse signal “p” further gives a curve “l”, as shown in FIG. 17, that indicates output light intensity versus pulse signal “p” at constant voltage of 1.3(Vp−Vth) but varying in R. M. S. with change in pulse width. The curve “l” indicates output light intensity at Vd/3 almost the same as at Vd in input-signal voltage in R. M. S., with degree of disclination at Vd/3 decreased almost to ⅓ of that at Vd, as indicated by the straight line “n”.

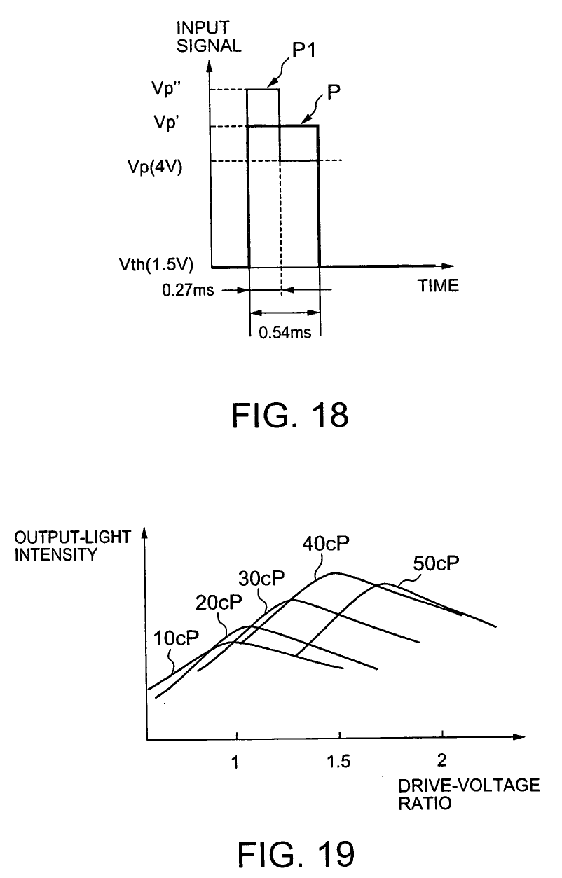

Discussed further is application of large liquid crystal drive voltage with reference to FIG. 18.

A pulse “p” in FIG. 18 is equivalent to the pulse “q” shown in FIG. 14. A pulse “p1” in FIG. 18 has the same display-on period as the pulse “p” but has a liquid crystal drive voltage (input signal) of (Vp″−Vth)=1.6(Vp−Vth) in the former half of the display-on period and (Vp−Vth) in the latter half thereof. The pulse signals “p” and “p1” have the same voltage in R. M. S.

The pulse signal “p1” gives output light intensity and degree of disclination versus input-signal voltage in R. M. S. almost the same as those for the pulse signal “p” (curve “l” and straight line “n” in FIG. 17).

Disclosed so far is about the liquid crystal display in this embodiment, using the liquid crystal having viscosity at 15 cp.

Discussed next with respect to FIG. 19 is evaluation of output-light intensity at Vd/6 in input-signal voltage in R. M. S. while varying drive voltage for liquid crystal displays using liquid crystals having viscosity at 10 cp, 20 cp, 30 cp, 40 cp, and 50 cp, respectively, in this embodiment.

FIG. 19 shows output light intensity versus liquid crystal drive voltage with change in liquid crystal viscosity.

Drive-voltage ratio on the axis of abscissas in FIG. 19 is a ratio of liquid crystal drive voltage during the display-on period to liquid crystal drive voltage (Vp−Vth). The display-on period is set as being in inverse proportion to the drive-voltage ratio, with constant input-signal voltage in R. M. S.

As indicated in FIG. 19, the liquid crystal having viscosity at 40 cp exhibits the maximum output light intensity at about 1.5 in drive-voltage ratio.

Output light intensity versus degree of disclination is evaluated, as a curve “k” in FIG. 17, for the liquid crystal having viscosity at 40 cp with change in display-on period, or voltage in R. M. S. for an input signal at about 1.5 in drive-voltage ratio.

The curve “k” shown in FIG. 17 indicates sufficient output light intensity (about 80% of saturated level) at Vd/6 in input-signal voltage in R. M. S., whereas the degree of disclination ⅙ at Vd/6 smaller than at Vd in input-signal voltage in R. M. S.

Another application is large drive voltage to the liquid crystal having 40-cp viscosity. The applied drive voltage is (Vp″−Vth)=2(Vp−Vth) in the former half of the display-on period and (Vp−Vth) in the latter half of the display-on period, different from the above case with 1.5 in drive-voltage ratio. This application of large drive voltage gives output light intensity and degree of disclination versus input-signal voltage in R. M. S. almost the same as at 1.5 in drive-voltage ratio.

As disclosed in detail, the method of driving the vertically aligned liquid crystal display in this embodiment produces large output light intensity while small degree of disclination in the range from Vd/6 to 5 Vd/6 in input-signal voltage in R. M. S., thus improving image quality.

Discussed next is the ratio of degree of disclination to pixel size under the optimum requirement (1:6 in ratio of display-on period to one-field period).

The ratio of degree of disclination to pixel size is examined by the method of driving the vertically aligned liquid crystal display in this embodiment for several liquid crystal displays.

The liquid crystal displays subjected to the examination are four types having the pixel pitches of 15 μm, 10 μm, 7.8 μm, and 5 μm, respectively, and different pretilt angles with varied angles θ1 (FIGS. 15 and 16). The viscosity of liquid crystals is 40 cp for all of the four types. The pixel interval is set as in proportion to the pixel pitch, for example, 1-μm interval to 15-μm pitch, and 0.33-μm interval to 5-μm pitch.

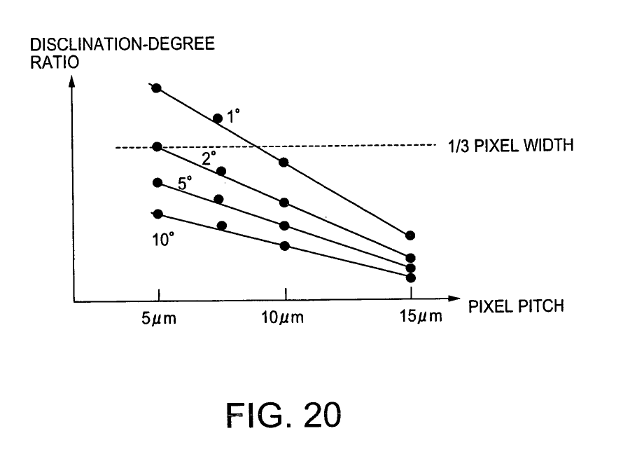

Indicated in FIG. 20 is the ratio of degree of disclination to pixel size (disclination-degree ratio) versus pixel pitch and pretilt angle, under the examination (simulation being conducted only at 5-μm pitch).

FIG. 20 teaches that: the disclination-degree ratio becomes higher as the pixel pitch becomes smaller at constant pretilt angle; the disclination-degree ratio becomes higher as the pretilt angle becomes smaller at constant pixel pitch; and about 10-μm pixel pitch is the maximum usable pitch at 1 degrees in pretilt angle for an allowable disclination-degree ratio of ⅓× pixel width.

Also taught by FIG. 20 is that liquid crystal displays having pretilt angles in the range from 2 to 10 degrees and pixel pitches in the range from 5 to 15 μm exhibit disclination-degree ratios smaller than ⅓× pixel width, thus improving image quality.

The contrast ratio depends largely on the pretilt angle. In other words, the smaller the pretilt angle, the higher the contrast ratio, or the larger the pretilt angle, the lower the contrast ratio. For example, a 10-degree pretilt angle gives the contrast ratio of about 150:1.

Nevertheless, the method of driving liquid crystals in this embodiment offers smaller pixel pitches for liquid crystal displays with relatively low contrast ratios. This is evident from FIG. 20 in which the driving method in this embodiment drastically lowers the disclination-degree ratio.

For display systems equipped with a liquid crystal display, the liquid crystal pretilt angle smaller than 1 degrees gives almost no improvements to contrast ratio and lowers the output-light rising response speed. This is because the contrast ratio for such systems depends on optical components.

(Comparison)

Comparison is made between the liquid crystal display equipped with the digital-drive active matrix substrate (embodiment) and a liquid crystal display equipped with the known analog-drive active matrix substrate for comparison.

Both displays have 15 μm in pixel pitch (14 μm×14 μm in pixel size) and θ1=63 degrees for the alignment film of a liquid crystal having viscosity of 15 cp.

An analog input signal is supplied to three aligned pixels of the liquid crystal display for comparison: a given voltage to the center pixel for displaying almost white; while the threshold voltage Vth to two pixels on both sides of the center pixel, for displaying black.

The liquid crystal display for comparison exhibits unallowable high degree of disclination, 1500:1 in contrast ratio, and 2.5 degrees in pretilt angle.

Further comparison is made between the liquid crystal display in this embodiment and another liquid crystal display equipped with the known analog-drive active matrix substrate for comparison, having 15 μm in pixel pitch (14 μm×14 μm in pixel size) and θ1=67 degrees for the alignment film of a liquid crystal having viscosity of 15 cp.

The liquid crystal display for further comparison exhibits 6 degrees in pretilt angle and allowable degree of disclination but low contrast ratio of 800:1, not suitable for high-contrast-ratio use.

As disclosed in detail, the method of driving a vertically aligned liquid crystal display in this embodiment achieves suppression of occurrence of disclination. In addition, the liquid crystal pretilt angle in the range from 2 to 5 degrees offers high contrast ratio for a vertically aligned liquid crystal display driven the by driving method.

The SiO₂-alignment film is formed by ion-beam deposition in production of the vertically aligned liquid crystal display in this embodiment.

Not only ion-beam deposition, such an alignment film can be formed by other techniques, such as, deposition, sputtering, ion-beam sputtering, chemical vapor deposition, ion plating, and etching.

Moreover, instead of the SiO₂-alignment film, a polyimide alignment film can be formed by rubbing or photo-induced alignment.

Rubbing, however, produces stripe unevenness in images at high contrast ratio of 1000:1 or higher. Stripe unevenness are highly noticeable in images of little bit brighter than black in vertically aligned liquid crystal displays for which normally-black (black being displayed while not driven) is the best mode in driving. This poses problems in image projection by a liquid crystal projector, etc.

In addition, organic films, such as polyimide films, are inferior to inorganic films, such as SiO₂ films, in light degradation at high intensity.

Therefore, the SiO₂-alignment film is the best choice for display systems with high intensity and high contrast ratio of 1000:1 or higher.

As disclosed above in detail, a vertically aligned liquid crystal display is driven by a digital drive signal according to a drive method in the invention. In detail, one field of each of pulses carried by the digital drive signal is divided into a plurality of subfields. Each subfield has a display-off period for which a liquid crystal is not driven and a display-on period for which the liquid crystal is driven. A ratio of the total of the display-on periods over the subfields to the one field is in the range from 1:6 to 5:6. At least a saturated drive voltage is supplied as the digital drive signal to the liquid crystal for each display-on period to modulate light incident in the liquid crystal.

The display-on period in each subfield may be divided into a plurality of sub-display-on periods when the display-on period in each subfield is longer than a period for which disclination occurs.

The drive method in the present invention therefore achieves display of images with high contrast and resolution but rare occurrence of disclination.

Moreover, according to the drive method in the present invention, a voltage larger than the saturated drive voltage may be supplied to liquid crystal, thus gaining sufficient amount light output from the liquid crystal while suppressing disclination.

1. A method of driving a vertically aligned liquid crystal display comprising the steps of:
dividing one field of each of pulses carried by a digital drive signal into a plurality of subfields, each subfield having a display-off period for which a liquid crystal is not driven and a display-on period for which the liquid crystal is driven, a ratio of the total of the display-on periods over the subfields to the one field being in the range from 1:6 to 5:6; and
supplying at least a saturated drive voltage as the digital drive signal to the liquid crystal for each display-on period to modulate light incident in the liquid crystal.

2. driving method according to claim 1 further comprising the step of dividing the display-on period in each subfield into a plurality of sub-display-on periods when the display-on period in each subfield is longer than a period for which disclination occurs.

3. The driving method according to claim 1, wherein the supplying step includes the step of supplying a voltage larger than the saturated drive voltage to the liquid crystal.
